(19) United States
(12) Patent Application Publication
(10) Pub. No.: US 2012/0072229 A1
(43) Pub. Date: Mar. 22, 2012

(54) COMMUNICATION, PROCESSING, AND DISPLAY OF SERVICE DESK CRITICAL ISSUE DATA

(75) Inventors: Jack Carlos ZALDIVAR, JR., Mico, TX (US); Matthew Dale WAGSTER, Converse, TX (US); Richard C. TALLINI, Boise, ID (US)

(73) Assignee: HARTFORD FIRE INSURANCE COMPANY, Hartford, CT (US)

(21) Appl. No.: 12/887,115

(22) Filed: Sep. 21, 2010

(51) Int. Cl. G06Q 10/00

(52) U.S. Cl. 705/1.1

(57) ABSTRACT

An architecture for the processing and display of service desk critical issue data may include an issue tracking system, an issue tracking system database, a reporting client module, a monitoring module, and a messaging client module. The monitoring module may obtain data related to critical issues that are stored in the issue tracking system database, and display the data. The monitoring module may also send messages to users that are affected by critical issues based on the data received from the issue tracking system database. Users may receive and view messages sent by the monitoring module using the messaging client module. The reporting client module may also display data related to critical issues that are stored in the issue tracking system database.

### TECHNICAL FIELD

The subject matter disclosed herein relates generally to computing systems, and more particularly to the electronic communication, processing, and display of data related to critical issues in service desk departments and other contexts.

### BACKGROUND

Many organizations have a service desk department that provides support to customers or employees. The services offered by a service desk department may vary depending whether the service desk department is inward-facing (serving workers of the organization) or outward-facing (serving outside customers of the organization), and depending on the purpose of the service desk department within its larger organization. For example, a service desk department may provide support for its organization's Information Technology (IT) infrastructure. When a worker in the organization has an issue using her computer, the worker may call the service desk department to report the issue. The benefits of a service desk department are particularly vital to organizations such as insurance providers. Such organizations may have employees at a central home office, as well as employees located throughout the United States and the world. Some of these outlying offices may have small staffs, but nonetheless require access to and the expertise of a service desk department.

A service desk department may use a number of different technologies to help manage and perform service desk functions. For example, a service desk department may use an issue tracking system to manage workflow and keep track of reported service outages and service requests. When a user contacts the service desk department to report an issue, the agent handling the issue will open a new entry (in many systems referred to as a “ticket”) in the issue tracking system. The agent may then add additional data related to the issue to the ticket, such as the users affected by the issue, or a detailed description of the issue. The ticket may then be assigned to a service desk agent to be resolved. When the assigned service desk agent performs work on the issue, the ticket is updated to reflect the agent's progress. When an issue has been resolved, the ticket may be updated to indicate that it has been resolved.

In some service desk departments, critical issues may be handled differently from non-critical issues. A service desk department may be expected, for example, to frequently communicate with users regarding the progress of critical issues, whereas a lesser amount of communication may be expected for non-critical issues. In addition, users may be interested in quickly obtaining information about critical issues that are affecting them. However, current technologies do not support communications from service desk agents to users regarding critical issues in an effective manner. Further, current technologies do not adequately provide ready access for users to information related to critical issues. Moreover, service desk agents and their supervisors are not provided with timely and meaningful information about the performance of individual agents or the overall performance of the service desk department. Accordingly, new technologies are required that overcome these and other shortcomings of the current technologies.

### SUMMARY

A system for the processing and display of service desk issue data may include at least one communications interface configured to receive information related to a service desk issue from a service desk issue database and at least one processor configured to determine whether the service desk issue is a critical issue or a non-critical issue. The apparatus may further include a display device configured to display information in response to a determination that the service desk issue is a critical issue. The displayed information may be based on the information received from the service desk issue database, and may include an identifier of the service desk issue, a time the service desk issue was reported, or a time that a next notification related to the service desk issue is expected to be sent.

A method for the processing and display of service desk issue data may include at least one communications interface receiving information related to a service desk issue from a service desk issue database and at least one processor determining whether the service desk issue is a critical issue or a non-critical issue. The method may further include displaying information on a display device in response to a determination that the service desk issue is a critical issue. The displayed information may be based on the information received from the service desk issue database, and may include an identifier of the service desk issue, a time the service desk issue was reported, or a time that a next notification related to the service desk issue is expected to be sent.

A computer-readable medium may have processor-executable instructions stored thereon which, when executed by at least one processor, will cause the at least one processor to perform a method for the processing and display of service desk issue data. The method may include receiving information related to a service desk issue from a service desk issue database and determining whether the service desk issue is a critical issue or a non-critical issue. The method may further include displaying information on a display device in response to a determination that the service desk issue is a critical issue. The displayed information may be based on the information received from the service desk issue database, and may include an identifier of the service desk issue, a time the service desk issue was reported, or a time that a next notification related to the service desk issue is expected to be sent.

### BRIEF DESCRIPTION OF THE DRAWINGS

A more detailed understanding may be had from the following description, given by way of example in conjunction with the accompanying drawings wherein:

FIG. 1 shows an example architecture for the communication, processing, and display of data related to critical issues in a service desk department;

FIG. 2 shows parameters for determining the level of criticality of an issue;

FIG. 3 shows a user interface element for the monitoring of critical service desk issues;

FIG. 4 shows a user interface element for transmitting messages to users that are affected by a critical service desk issue;

FIG. 5 shows a user interface element for displaying a message to a user that is affected by a critical service desk issue;

FIG. 6 shows a user interface element for displaying data related to critical service desk issues;

FIG. 7 shows an example method for the communication, processing, and display of data related to critical issues in a service desk department or other organization; and

FIG. 8 shows a computing device that may be used to implement the features described herein with reference to FIGS. 1-7.

### DETAILED DESCRIPTION

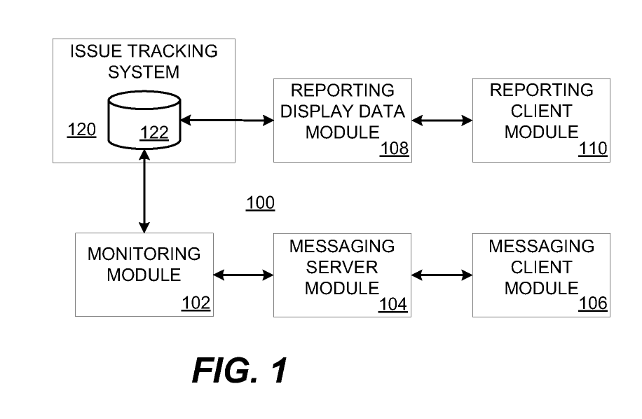

FIG. 1 shows an example architecture 100 for the communication, processing, and display of data related to critical issues in a service desk department or other organization. The example architecture 100 includes an issue tracking system 120, an issue tracking system database 122, a monitoring module 102, a messaging server module 104, a messaging client module 106, a reporting display data module 108, and a reporting client module 110.

The issue tracking system 120 may be used by a service desk department to record information about and track reported incidents and service requests. The issue tracking system 120 may store a “ticket” per reported incident or service request. Data associated with the ticket may include the time the ticket was opened, the user/customer who initiated the ticket, the service desk agent who opened the ticket, the service desk agent who is assigned to resolve the ticket, a current status of the ticket, historical data regarding efforts made to resolve the ticket, or other data, a level of criticality associated with the ticket, and/or other parameters. The issue tracking system 120 may store this data in the issue tracking system database 122. The issue tracking system 120 may include a web server (not depicted) or other server (not depicted) that provides an interface for adding new tickets, modifying ticket information, and/or viewing ticket information.

The issue tracking system 120 may be used by a service desk department to handle a variety of different issues. The issues may include, for example, incidents or service requests related to software, hardware, or other infrastructure. As one example, the issue tracking system 120 may be used by an internal-facing service desk department in an insurance and/or investment company. In this example, employees of the company may contact the service desk department when they encounter issues with the systems that they use to submit insurance claims for customers, process insurance claims, perform stock trades, maintain compliance with insurance laws, or maintain compliance with Securities and Exchange Commission (SEC) regulations.

The monitoring module 102 may monitor the data in the issue tracking system database 122 to obtain data related to critical issues stored in the issue tracking system database 122. The monitoring module 102 may obtain data from the issue tracking system database 122 by periodically querying the issue tracking system database 122. Alternatively or additionally, the monitoring module 102 may be notified of new data and/or changes in data at the issue tracking system database 122 via event notifications. According to this approach, when a new critical issue is added or data related to a critical issue in the database is added or modified, the issue tracking system database 122 may send one or more notification messages to the monitoring module 102, reporting the addition or change of data.

The monitoring module 102 may also display one or more user interface elements that permit a user to view the data obtained from the issue tracking system database 122. Further, the monitoring module 102 may send notification messages to users that are affected by a critical issue via the messaging server module 104. The messaging server module 104 may send the messages to the messaging client module 106, which may then display the messages to a user.

The transmission of messages from the monitoring module 102 to the messaging client module 106 may be performed using a number of different technologies, such as email, instant messaging, Rich Site Summary (RSS), and/or other communication technologies. In an instance where email is used, the messaging server module 104 may be an email server such as a Microsoft Exchange server, a Sendmail server, an Exim server, or other appropriate server. In such an instance, the messaging client module 106 may be or include an email client application such as Microsoft Outlook, Thunderbird, a web browser, or any other application configurable to receive an email message. Further, the monitoring module 102 may send the notification messages to the messaging server module 104 using a technology such as Simple Mail Transfer Protocol (SMTP), a Remote Procedure Call (RPC) technology, or other appropriate protocol. The identities of the users that are affected by a critical issue (and, therefore, to whom notification messages should be sent by the monitoring module 102) may be determined in a number of different ways. As one example, a critical issue may be associated with a department or other organizational sub-division within an organization. In such an instance, the monitoring module 102 may use an email distribution list that is associated with the department or organization sub-division to send notification messages to the appropriate users. In various implementations, the email distribution list may be managed by the monitoring module 102 and/or the messaging server module 104.

As an alternative to the architecture 100 of FIG. 1, the messaging client module 106 may receive notification messages directly from the monitoring module 102, without the use of a module such as the messaging server module 104.

The reporting display data module 108 may provide data from the issue tracking system database 122 to the reporting client module 110. The reporting client module 110 may display one or more user interface elements that permit a user to view the data obtained from the issue tracking system database 122. The reporting display data module 108 and reporting client module 110 may be implemented using a number of different technologies. As an example, the reporting client module 110 may be or include a graphical client application, based on a technology such as Microsoft Foundation Classes (MFC), Windows Presentation Foundation (WPF), Qt, Gimp Toolkit (GTK+), or other appropriate technology. In such an instance, the reporting client module 110 may send queries or other requests for information to the reporting display data module 108. The reporting display data module 108 may obtain the requested data from the issue tracking system database 122 and return the data to the reporting client module 110 for display.

Alternatively or additionally, the reporting display data module 108 may be a web server that includes or is connected to a server-side scripting engine or similar module, and the reporting client module 110 may be a web browser or similar application. In such an instance, the reporting client module 110 may send Hyper Text Transfer Protocol (HTTP) requests to the reporting display data module 108. The reporting display data module 108 may receive the requests, obtain data from the issue tracking system database 122, and return web pages to the reporting client module 110 (described using, e.g., Hyper Text Markup Language (HTML)) that include the obtained data. Appropriate server-side scripting technologies for this purpose may include, for example, Active Server Pages (ASP), PHP: Hypertext Preprocessor (PHP), or Ruby on Rails (RoR).

In a variation on the architecture 100 of FIG. 1, the reporting client module 110 may obtain data directly from the issue tracking system database 122, without the use of a module such as the reporting display data module 108. The reporting client module 110 may perform this action by, for example, directly querying the issue tracking system database 122.

Each of the modules 102, 108, 110 shown in FIG. 1 may be implemented as software modules, as specific-purpose processors, or as combinations thereof. When implemented as software, a module 102, 108, 110 may be implemented as an executable program, an executable application, a function, a method call, a procedure, a routine or sub-routine, a set of processor-executable instructions, a script or macro, an object, a data structure, or any other appropriate software construct.

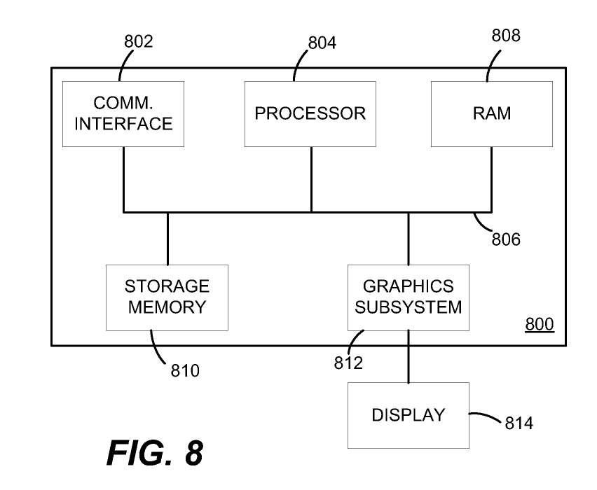

The architecture 100 of FIG. 1 may be implemented using a number of different network topologies and computing devices. For example, each of the issue tracking system 120, issue tracking system database 122, monitoring module 102, reporting display data module 108, and reporting client module 110 may be implemented using a single computing device, as one or more separate computing devices, or spread across any two or more computing devices, in any combination. When spread across two or more computing devices, wired or wireless networking may be used for communication between these entities 120, 122, 102, 108, 110. Wired or wireless network may involve the use of technologies such as but not limited to Transmission Control Protocol (TCP), User Datagram Protocol, Internet Protocol (IP), Ethernet, Digital Subscriber Line (DSL), Wireless Local Area Network (WLAN), wireless cellular technology, and/or any other appropriate technology related to wired or wireless communications. An example of a computing device that may be used for the implementation of any or any combination of these entities 120, 122, 102, 108, 110 is the computing device 800 that is described below with reference to FIG. 8.

In various implementations, each or any combination of the entities 120, 102, 108, 110 described above may determine the level of criticality associated with a ticket. The issue tracking system database 122 may include one or more fields that store information that indicates the criticality of an issue. The fields may include, for example, a Boolean field that indicates whether an issue is critical or not. Alternatively or additionally, the fields may include an enumerated field with possible values that indicate a level of criticality (e.g., Critical, High Criticality, Medium Criticality, or Low Criticality), may include an integer field that indicates criticality according to a graduated scale (e.g., a scale from one to five where one end of the scale indicate a low criticality and the other end of the scale indicated a high criticality), and/or may include other types of data. When a new ticket is added to the issue tracking system database 122, the issue tracking system 120 may analyze the attributes of the new ticket and populate the criticality-related fields accordingly. In such an instance, the monitoring module 102, reporting display data module 108, and/or the reporting client module 110 may obtain data from the issue tracking system database 122 by querying the issue tracking system database 122 based on the criticality-related fields. As an example: In an instance where the issue tracking system database 122 includes a Boolean “Critical” field that indicates whether an issue is critical or not, the monitoring module 102 may monitor the issue tracking system database 122 by periodically querying the database 122 for recent issues for which the Critical field is set to a value of True. The reporting display data module 108 and/or the reporting client module 110 may obtain data from the issue tracking system database 122 in a similar fashion.

Alternatively or additionally, the monitoring module 102, reporting display data module 108, and/or the reporting client module 110 may determine the level of criticality associated with an issue without regard to whether the issue tracking system database 122 includes criticality-related values. As one example, the monitoring module 102 may be configured such that all issues that affect greater than five users are considered to be critical. In this example, the monitoring module 102 may monitor the issue tracking system database 122 by periodically querying the database 122 for only those issues which affect more than five users. The reporting display data module 108 and/or the reporting client module 110 may obtain data from the issue tracking system database 122 in a similar fashion. Alternatively or additionally, the monitoring module 102 may monitor the issue tracking system database 122 by periodically querying the database 122 for new issues. After receiving information related to the new issues, the monitoring module 102 may determine the level of critically associated with the issue.

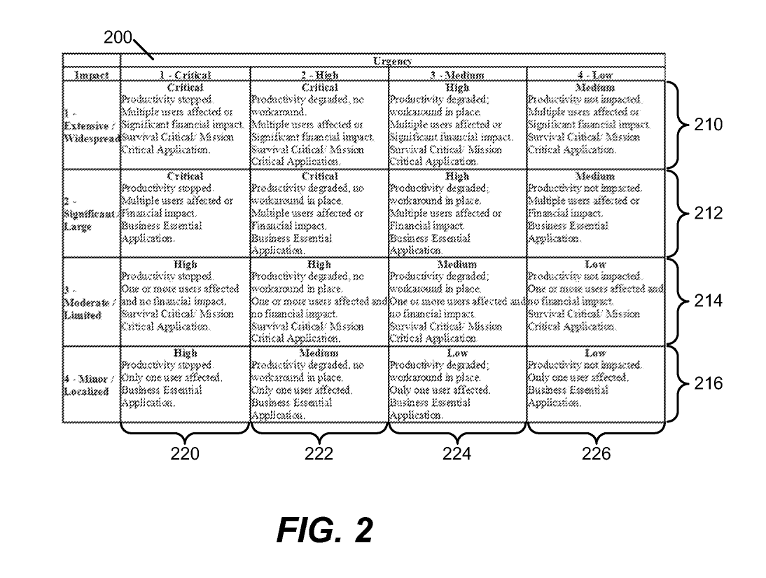

FIG. 2 shows a table 200 that describes parameters for determining the level of criticality of an issue. The table 200 includes four rows: row one 210; row two 212; row three 214; and row four 216. The table 200 also includes four columns: column one 220; column two 222; column three 224; and column four 226. The table 200 shows that both the potential impact of and urgency of an issue may affect whether the issue is considered critical. Further as shown in the table 200, parameters that may be used to determine whether an issue is critical or not include: to what extent productivity is affected; how many users are affected; the potential financial impact of an issue; and whether the issue is related to a survival critical or mission critical application. As shown in FIG. 2, the parameter values described in the following locations in the table 200 correspond to critical issues: (column one 220, row one 210); (column one 220, row two 212); (column two 222, row two 212); and (column two 222, row two 212). In various implementations, variations on the table 200 of FIG. 2 may be used, adjusted as appropriate to suit the needs of the users of the architecture 100 of FIG. 1.

Referring both to FIG. 1 and FIG. 2, each or any combination of the issue tracking system 120, monitoring module 102, reporting display data module 108, and reporting client module 110 may determine the level of criticality of an issue based on the parameters described in the table 200 of FIG. 2. For example, the issue tracking system 120 may be configured to populate fields in the issue tracking system database 122 that describe the criticality of an issue according to the classifications shown in the table 200 of FIG. 2. Alternatively or additionally, monitoring module 102 may be configured to determine the level of criticality of an issue based on the classifications shown in the table 200 of FIG. 2. In this example, the monitoring module 102 may monitor the issue tracking system database 122 by periodically querying the database 122 for only those issues which meet the criteria for being characterized as “Critical” as shown in the table 200 of FIG. 2. The reporting display data module 108 and/or the reporting client module 110 may obtain data from the issue tracking system database 122 in a similar fashion.

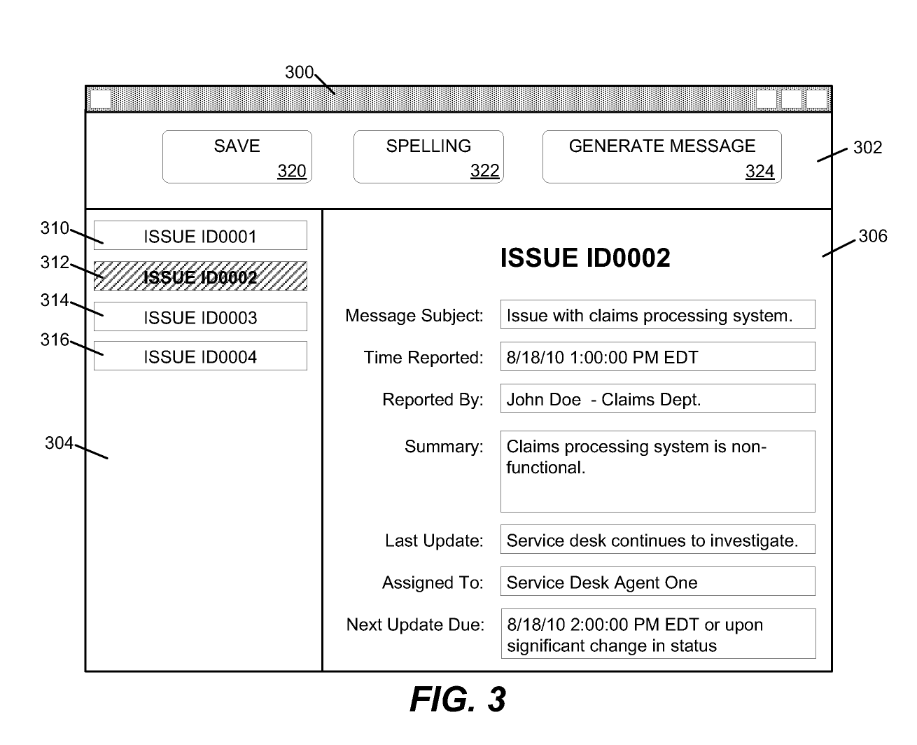

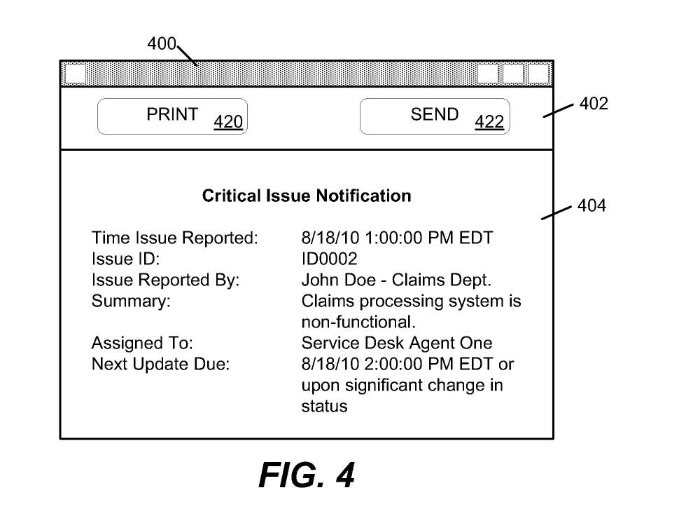

FIGS. 3 and 4 show display elements 300, 400 that may be displayed by the monitoring module 102 of FIG. 1. FIG. 3 shows a critical issue monitoring element 300, which displays data related to critical issues. FIG. 4 shows a message transmission element 400, which initiates the transmission of messages to users that are affected by a critical issue via the messaging server module 104 and/or the messaging client module 106. As will be described in further detail below, the critical issue monitoring element 300 may receive input from a user, and the monitoring module 102 may initiate the display of the message transmission element 400 in response to the user input. Also as will be described in further detail below, the display elements 300, 400 may be used by a service desk agent or other users to perform service desk functions or other functions.

The critical issue monitoring element 300 may include a control area 302, an issue list area 304, and an issue display area 306. The monitoring module 102 may receive information related from the issue tracking system database 122 as described above with reference to FIG. 1. After receiving information related to an issue, the monitoring module 102 may determine whether the issue is a critical issue or a non-critical issue, based on parameters such as those described above with reference to FIGS. 1 and 2. If the monitoring module 102 determines that the issue is a critical issue, the monitoring module 102 may add a display element to the issue list area 304 that corresponds to the critical issue.

FIG. 3 shows an example wherein the issue list area 304 includes four display elements 310, 312, 314, 316 that correspond to four critical issues that have identifiers “ID0001,” “ID0002,” and “ID0003,” and “ID0004.”

A user may select one of the display elements 310, 312, 314, 316 in the issue list area 304. The selection may be performed, for example, by the user clicking a mouse or providing an input via a different type of input device. When one of the display elements 310, 312, 314, 316 in the issue list area 304 is selected, information related to the corresponding issue may be displayed in the issue display area 306. Further, the appearance of a selected display element 310, 312, 314, 316 in the issue list area 304 may be changed based on whether the display element is selected or not. In FIG. 3, for example, the “ID0002” display element 312 has a different appearance from the other display elements 310, 314, 316.

The issue display area 306 may include a number of fields that indicate data related to a critical issue. In the example of FIG. 3, the issue display area 306 displays data related to the issue with identifier “ID0002” that is displayed in the “ID0002” display element 312 in the issue list area 304. The issue display area 306 may include any combination of the following data associated with a critical issue: an identifier; a time the issue was reported; an indicator of the person who reported the issue, and/or other information such as a department name associated with the person who reported the issue; a summary of the issue; information that describes a last update performed by a service desk analyst; a time that a last update related to the issue was communicated by a service desk analyst; a name of a service desk analyst to whom the issue is assigned; and a time at which a next update related to the issue is due. The issue display area 306 may also include a field that indicates a message subject that may be used for the generation of a message for transmission to the users that are affected by the issue.

The control area 302 may include a number of display elements that may receive user input and initiate an action by the monitoring module 102 in response to the input. In FIG. 3, for example, the control area 302 includes a Save display element 320, a Spelling display element 322, and a Generate Message display element 324. In response to a selection of the Save display element 320, the monitoring module 102 may store the data that is displayed in the critical issue monitoring element 300 in a computer-readable storage medium. In response to a selection of the Spelling display element 322, the monitoring module 102 may perform a spell check of the text in the fields displayed in the issue display area 306. In response to a selection of the Generate Message display element 324, the monitoring module 102 may display a message transmission element 400, as shown in FIG. 4 and described in further detail below.

Alternatively or additionally, the control area 302 may include an Intermediary Tickets display element (not depicted). In response to a selection of the Intermediary Tickets display element, another display area (not depicted) may be displayed that includes a listing of critical issues for which an initial notification message has not yet been sent to affected users. The control area 302 may also include a Resolved Issue display element (not depicted). When the Resolved Issue element is selected, a critical issue that currently has a resolved status (and, therefore, for which no further notification messages are required) may be removed from the critical issue monitoring element 300. This may include, for example, the removal of a display element in the issue list area 304 that corresponds to the resolved issue. The control area may also include a Message History display element (not depicted). When the Message History display element is selected, another display element (not depicted) may be displayed that include information about messages that have been sent using the monitoring module 102 in the past. This historical information may include information such as when a message was sent, the contents of the message, and an identifier of a user who sent the message.

Alternatively or additionally, the control area 302 may include a Turnover display element (not depicted). When the Turnover display element is selected, the monitoring module 102 may send one or more messages to service desk analysts and/or managers that indicate that a user of the critical issue monitoring element 300 will be ending their shift, and so will no longer be using the critical issue monitoring element 300 to monitor critical issues. The messages may be, for example, email messages or other types of messages. The control area 302 may also include an Open Issue Summary display element (not depicted). When the Open Issue Summary display element is selected, the monitoring module 102 may send one or more messages to service desk analysts and/or managers that provide an overview of currently open critical issues that are being monitored and shown in the critical issue monitoring element 300. The messages may include information that summarizes the open critical issues, and/or include any of the types of information shown in the issue display area 306. The messages may be, for example, email messages or other types of messages.

The monitoring module 102 may vary the appearance of the display elements 310, 312, 314, 316 shown in the issue list area based on the current status of the issue that corresponds to the display element. The monitoring module 102 may use different fonts, highlighting, background coloring, and/or other approaches to indicate whether an issue is open or has been resolved. A display element in the issue list area 304 may be displayed with a dark gray font and lighter gray background (achieving a “grayed out” effect) when an issue corresponding to the display element has been indicated as resolved. Alternatively or additionally, the display elements 310, 312, 314, 316 in the issue list area 304 may be displayed differently based on a time at which a next update related to the corresponding issue is due and/or whether the last expected update was been timely sent or is overdue. As one example, a next update for the critical issue with identifier ID0002 may be due at 2:00 PM. At earlier than fifteen minutes prior to when the next update message is due, the display element 312 that corresponds to issue ID0002 may be colored in green to indicate that a next update is due in the future, but not soon in the future. At fifteen minutes prior to when the update is due (1:45 PM), the display element 312 that corresponds to issue ID0002 may be colored in yellow to indicate that the deadline for sending the update is approaching. If the update is not sent by 2:00 PM, the display element 312 that corresponds to issue ID0002 may be colored in red to indicate that the update is overdue. When an update message related to the issue is later sent, the display element 312 that corresponds to the issue may be returned to the original green color.

FIG. 4 shows a message transmission element 400 that includes a control area 402 and a message contents preview area 404. The message contents preview area 404 displays a preview of the contents of a message that may be transmitted to the messaging client module 106 by way of the messaging server module 104. The text in the message contents preview area 404 may be based on the data displayed in the issue display area 306 of the critical issue monitoring element 300 described above with reference to FIG. 3. The text in the message contents preview area 404 may further be editable based on input from a user.

The control area 402 may include a number of display elements that may receive user input and initiate an action by the monitoring module 102 in response to the input. In FIG. 4, for example, the control area 402 includes a Print display element 420 and a Send display element 422. In response to a selection of the Print display element 420, the monitoring module 102 may initiate the printing of the contents of the message contents preview area 404. In response to a selection of the Send display element 422, the monitoring module 102 may send a message to the messaging server module 104 (for subsequent transmission to the messaging client module 106), with the contents of the message being based on the text displayed in the message contents preview area 404.

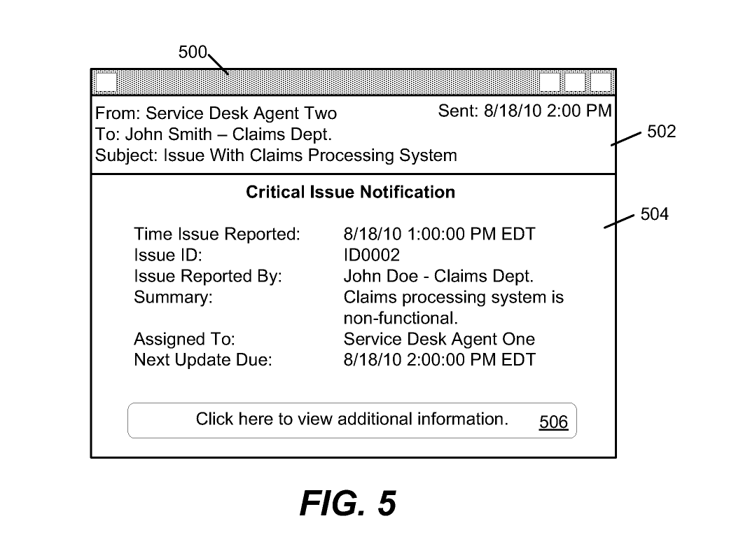

FIG. 5 shows a message display element 500 that may be displayed by the messaging client module 106 of FIG. 1. The message display element 500 may include a header area 502 and a contents area 504. The header area 502 may include information related to the transmission and/or reception of the message. For example, the header area 502 may indicate the sender of the message, the recipient of the message, subject text related to the message, and a time that the message was sent. In an instance where the messaging client module 106 is an email client application, the header area 502 may indicate, for example, the email address of the sender and the email address of the recipient.

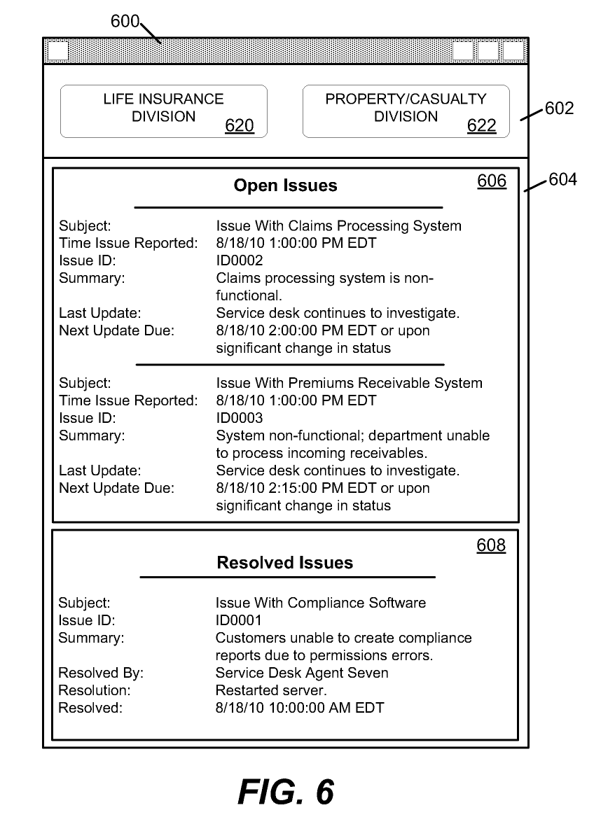

The contents area 504 may display the contents of the message. The contents area 504 may additionally include a link display element 506. The link display element 506 may receive user input, and in response to the user input, the monitoring module 102 may initiate the display of further information related to the critical issue displayed in the contents area 504. The link display element 506 may be implemented as a hyperlink or other type of user interface element. As one example, the monitoring module 102 may initiate the display of data related to the critical issue by the reporting client module 110 in the display element 600 of FIG. 6, which is described in further detail below. Alternatively or additionally, other modules may be used to display additional data related to the critical issue in response to selection of the link display element 506.

In FIGS. 3-5, an example issue (with identifier “ID0002”) is displayed in the critical issue monitoring element 300, message transmission element 400, and message display element 500. As shown above, this example issue is indicated as having an open status. In various implementations, the critical issue monitoring element 300, message transmission element 400, and message display element 500 may also be configured to communicate, process, and display data related to issues that have a resolved status. In such an instance, the issue display area 306 of FIG. 3 may display information that relates to a resolved issue, such as the time the issue was resolved, which service desk agent resolved the issue, or other information. Further, the message contents preview area 404 of FIG. 4 and the data a contents area 504 of FIG. 5 may contain similar information that pertains to a resolved issue.

FIG. 6 shows a critical issue reporting display element 600 that may be displayed by the reporting client module 110 of FIG. 1. The critical issue reporting display element 600 includes a control area 602 and a contents area 604. The contents area 604 may include an open issues area 606. The open issues area 606 may display information related to critical issues in the issue tracking system 120 that have an open status. Alternatively or additionally, the contents area 604 may include a resolved issues area 608 that shows information related to critical issues that have been resolved. The control area 602 may include a number of display elements that may receive user input and initiate an action by the reporting client module 110 to change the data shown in the contents area 604 in response to the input. The reporting client module 110 of FIG. 1 may obtain the data shown in the reporting display element 600 from the issue tracking system database 122 using any or any combination of the approaches described above with reference to FIGS. 1-2.

FIG. 6 shows an example wherein the reporting client module 110 is used in the context of an insurance company that includes a Life Insurance Division and a Property/Casualty Division. According to this example, the control area 602 of FIG. 6 includes a Life Insurance Division display element 620 and a Property/Casualty Division display element 622. In response to a selection of the Life Insurance Division display element 620, the contents area 604 may display only critical issues that affect the Life Insurance Division in the insurance company. Similarly, in response to a selection of the Property/Casualty Division display element 622, the data shown in the contents area 604 may includes only critical issues that affect the Property/Casualty Division of the insurance company. The control area 602 may also include a display element (not depicted) such that, in response to user input, the data shown in the contents area 604 includes issues affecting all divisions within the insurance company.

Alternatively or additionally, the control area 602 may display elements that control the display of data in the contents area 604 based on other factors, such as how recently an issue was reported, whether an issue is open or resolved, how recently an issue was resolved, the application or system that is affected by an issue (e.g., a stock trading system, a claims processing system, or other type of system), any parameters described above as stored in the issue tracking system database 122, and/or other parameters. In an instance where the reporting client module 110 is a web browser and the reporting display data module 108 is a web server, the display elements 620, 622 in the control area 602 may be implemented as hyperlinks.

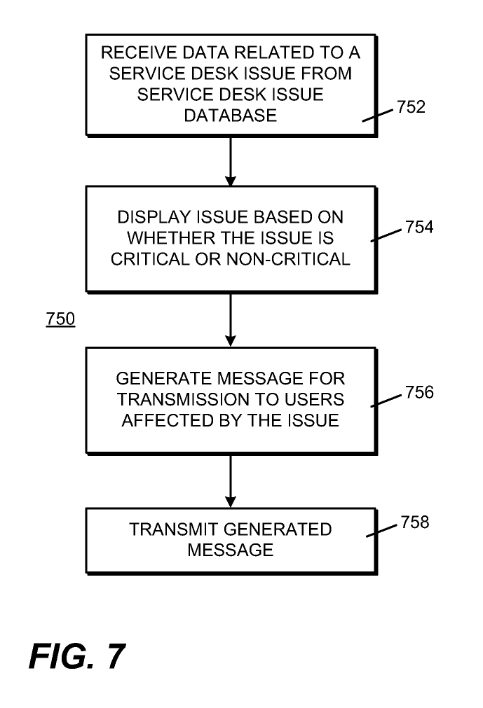

FIG. 7 shows an example method 750 for the communication, processing, and display of data related to critical issues in a service desk department or other organization. The example method 750 of Figure may be performed using the example architecture 100 of FIG. 1, or any other appropriate architecture.

As shown in FIG. 7, data may be received from a service desk issue database, related to a service desk issue (step 752). As an example, the service desk issue may relate to a service interruption for an application and/or other system that is used to submit insurance claims for customers, process insurance claims, perform stock trades, maintain compliance with insurance laws, or maintain compliance with SEC regulations. The data may be received, for example, by the issue tracking system 120, the issue tracking system database 122, the monitoring module 102, and/or any other appropriate module.

A determination may then be made as to whether the service desk issue is a critical issue or a non-critical issue, and the issue may be displayed based on the determination (step 754). This may be performed, for example, by the monitoring module 102, or any other appropriate module.

A message may then be generated for transmission to users who are affected by the issue (step 756). The may be performed, as an example, by the monitoring module 102, or any other appropriate module. Alternatively or additionally, this may be performed using user interface element such as the critical issue monitoring element 300 of FIG. 3, the message transmission element 400 of FIG. 4, and/or any other appropriate display element.

The generated message may then be transmitted to the users who are affected by the issue (step 758). This may be performed, for example, by one of or any combination of the monitoring module 102, the messaging server module 104, the messaging client module 106, and/or any other appropriate module.

FIG. 8 shows an example computing device 800 that is configurable to implement features described above with reference to FIGS. 1-7. The computing device 800 may include a processor 804, a communications interface 802, RAM 808, storage memory 810, graphics subsystem 812, display device 814, and system bus 806. These components 802, 804, 808, 810, 812, and 814 may be operatively coupled via the system bus 806.

The processor 804 may be configurable to store and read data from registers and execute instructions that perform any feature or combination of features described above with reference to FIGS. 1-7. The computing device 800 may also include one or more additional processors (not depicted) which may be operatively coupled to the other components 802, 804, 808, 810, 812, and 814 in the computing device 800 via the system bus 806.

The computing device 800 may receive input data through communications interface 802. The communications interface 802 may be, for example, a communications port, a wired or wireless transceiver or network interface, or an interface such as a Universal Serial Bus (USB) interface for receiving input from a user (not depicted) or an external computer-readable medium (not depicted). The computing device 800 may include additional data interfaces (not depicted). The storage memory 810 may be, for example, a hard disk drive, flash memory, or device capable of reading data from at least one non-volatile computer-readable medium. The RAM 808, the storage memory 810, and/or other computer-readable media (not depicted) within computing device 800 may be configurable to store instructions and/or data related to the implementation of any feature or combination of features described above with reference to FIGS. 1-7.

The graphics subsystem 812 is configurable to generate graphics data to display graphics such as the graphics described above with reference to FIGS. 1-7. Display device 814 is capable of rendering the data sent from the graphics subsystem 812 in a visual format. The display device 814 may be, for example, a monitor or television display, a plasma display, a liquid crystal display (LCD), or a display based on technologies such as front or rear projection, light emitting diodes (LEDs), organic light-emitting diodes (OLEDs), or Digital Light Processing (DLP). The display device 814 may be included within an external casing that encloses the computing device 800, or may be implemented externally to the computing device 800 and coupled to the computing device 800 via one or more wired or wireless interfaces.

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. When referred to herein, the term “computer-readable storage medium” broadly refers to and is not limited to a register, a cache memory, a read-only memory (ROM), a semiconductor memory device (such as a Dynamic Random Access Memory (D-RAM), Static RAM (S-RAM), or other RAM, a magnetic medium such as a flash memory, a hard disk, a magneto-optical medium, an optical medium such as a CD-ROM, a digital versatile disk (DVDs), or Blu-Ray disc (BD), other volatile or non-volatile memory, or other type of device for electronic data storage.

As used herein, the term “display device” broadly refers to and is not limited to a monitor or television display, a plasma display, a liquid crystal display (LCD), or a display based on technologies such as front or rear projection, light emitting diodes (LEDs), organic light-emitting diodes (OLEDs), or Digital Light Processing (DLP). When referred to hereafter, the term “input device” broadly refers to and is not limited to a keyboard, a mouse, a trackball, a scanner, a touch screen, a touch pad, a stylus pad, and/or other device that generates electronic signals based on interactions with a human user. Input devices may operate using technologies such as Bluetooth, Universal Serial Bus (USB), PS/2, or other technologies for data transmission.

As used herein, the term “database” broadly refers to and is not limited to a flat file, spreadsheet, structured file, relational database file, or any other form of organized data stored on a computer-readable storage medium. As used herein, the terms “user interface element” and “display element” broadly refer to and are not limited to a window, icon, text box, menu, graphical button, list, region, area, widget, visual artifact, or other construct that may be displayed in a user interface on a display device. A user interface element/display element may include other user interface elements/display elements.

Although features and elements are described above in particular combinations, each feature or element can be used alone without the other features and elements or in various combinations with or without other features and elements. The sub-elements of the methods and features as described above with respect to FIGS. 1-8 may be realized in any order (including concurrently), in any combination or sub-combination. Sub-elements described with reference to any single Figure may be used in combination with the sub-elements described with reference to any other Figure or combination of other Figures.

What is claimed is:

1. A system for the processing and display of service desk issue data, the system comprising:
at least one communications interface configured to receive service desk issue data related to a service desk issue, wherein the service desk issue data includes one or more of:
an identifier of the service desk issue;
a time the service desk issue was reported; or
a time that a next notification related to the service desk issue is expected to be sent;
at least one processor configured to determine whether the service desk issue is a critical issue or a non-critical issue based on the service desk issue data; and
a display device configured to display the service desk issue data in response to a determination by the at least one processor that the service desk issue is a critical issue.

2. The system of claim 1, wherein the service desk issue relates to an interruption in service for one or more systems related to:
submitting insurance claims;
processing insurance claims;
performing stock trades;
maintaining compliance with insurance laws; or
maintaining compliance with Securities and Exchange Commission (SEC) regulations.

3. The system of claim 1, wherein the determining whether the service desk issue is a critical issue or a non-critical issue is based on one or more of:
a number of users affected by the service desk issue;
whether a workaround for the service desk issue is available;
whether a significant financial impact is associated with the service desk issue; or
whether the service desk issue is related to a mission critical application.

4. The system of claim 1, wherein the service desk issue data further includes one or more of:
a summary of the service desk issue;
an identifier of a service desk agent responsible for handling the service desk issue;
an identifier of a person who reported the service desk issue;
an identifier of a department or other organizational entity associated with the person who reported the service desk issue; or
information that describes a last action on the service desk issue performed by a service desk analyst.

5. The system of claim 1, wherein:
the at least one processor is further configured to generate a message to be transmitted to a user affected by the service desk issue, wherein contents of the message are based on the service desk issue data; and
the at least one communications interface is further configured to transmit the message to the user affected by the service desk issue.

6. The system of claim 5, wherein the message is an email message, and wherein the at least one communications interface is configured to transmit the message to the user affected by the service desk issue via an email server.

7. The system of claim 5, wherein the message includes one or more of:
an identifier of the service desk issue;
a time the service desk issue was reported;
a summary of the service desk issue;
an identifier of a service desk agent responsible for handling the service desk issue; or
a time that a next notification related to the service desk issue is expected to be sent.

8. The system of claim 5, wherein:
the display device is further configured to display the contents of the message prior to transmitting the message to the user affected by the service desk issue; and
the at least one processor is further configured to receive an input from a user, wherein the input indicates that the message should be transmitted; and
the at least one communications interface is configured to transmit the message to the user affected by the service desk issue in response to the input from the user.

9. A method for the processing and display of service desk issue data, the method comprising:
at least one communications interface receiving service desk issue data related to a service desk issue, wherein the service desk issue data includes one or more of:
an identifier of the service desk issue;
a time the service desk issue was reported; or
a time that a next notification related to the service desk issue is expected to be sent;
at least one processor determining whether the service desk issue is a critical issue or a non-critical issue based on the service desk issue data; and
displaying the service desk issue data on a display device in response to a determination by the at least one processor that the service desk issue is a critical issue.

10. The method of claim 9, wherein the service desk issue relates to an interruption in service for one or more systems related to:
submitting insurance claims;
processing insurance claims;
performing stock trades;
maintaining compliance with insurance laws; or
maintaining compliance with Securities and Exchange Commission (SEC) regulations.

11. The method of claim 9, wherein the determining whether the service desk issue is a critical issue or a non-critical issue is based on one or more of:
a number of users affected by the service desk issue;
whether a workaround for the service desk issue is available;
whether a significant financial impact is associated with the service desk issue; or
whether the service desk issue is related to a mission critical application.

12. The method of claim 9, wherein the service desk issue data further includes one or more of:
a summary of the service desk issue;
an identifier of a service desk agent responsible for handling the service desk issue;
an identifier of a person who reported the service desk issue;
an identifier of a department or other organizational entity associated with the person who reported the service desk issue; or
information that describes a last action on the service desk issue performed by a service desk analyst.

13. The method of claim 9, further comprising:
the at least one processor generating a message to be transmitted to a user affected by the service desk issue, wherein contents of the message are based on the service desk issue data; and
the at least one communications interface transmitting the message to the user affected by the service desk issue.

14. The method of claim 13, wherein the message is an email message, and wherein transmitting the message to the user affected by the service desk issue is performed via an email server.

15. The method of claim 13, wherein the message includes one or more of:
an identifier of the service desk issue;
a time the service desk issue was reported;
a summary of the service desk issue;
an identifier of a service desk agent responsible for handling the service desk issue; or
a time that a next notification related to the service desk issue is expected to be sent.

16. The method of claim 13, further comprising:
prior to transmitting the message to the user affected by the service desk issue, displaying the contents of the message on the display device; and
receiving an input from a user, wherein the input indicates that the message should be transmitted;
wherein transmitting the message to the user affected by the service desk issue is performed in response to the input from the user.

17. A computer-readable medium having processor-executable instructions stored thereon which, when executed by at least one processor, will cause the at least one processor to perform a method for the processing and display of service desk issue data, the method comprising:
receiving service desk issue data related to a service desk issue, wherein the service desk issue data includes one or more of:
an identifier of the service desk issue;
a time the service desk issue was reported; or
a time that a next notification related to the service desk issue is expected to be sent;
determining whether the service desk issue is a critical issue or a non-critical issue based on the service desk issue data; and
displaying the service desk issue data on a display device in response to a determination by the at least one processor that the service desk issue is a critical issue.

18. The computer-readable medium of claim 17, wherein the service desk issue relates to an interruption in service for one or more systems related to:
submitting insurance claims;
processing insurance claims;
performing stock trades;
maintaining compliance with insurance laws; or
maintaining compliance with Securities and Exchange Commission (SEC) regulations.

19. The computer-readable medium of claim 17, wherein the determining whether the service desk issue is a critical issue or a non-critical issue is based on one or more of:
a number of users affected by the service desk issue;
whether a workaround for the service desk issue is available;
whether a significant financial impact is associated with the service desk issue; or
whether the service desk issue is related to a mission critical application.

20. The computer-readable medium of claim 17, wherein the service desk issue data further includes one or more of:
a summary of the service desk issue;
an identifier of a service desk agent responsible for handling the service desk issue;
an identifier of a person who reported the service desk issue;
an identifier of a department or other organizational entity associated with the person who reported the service desk issue; or
information that describes a last action on the service desk issue performed by a service desk analyst.

21. The computer-readable medium of claim 17, wherein the method further comprises:
generating a message to be transmitted to a user affected by the service desk issue, wherein contents of the message are based on the service desk issue data; and
transmitting the message to the user affected by the service desk issue.

22. The computer-readable medium of claim 21, wherein the message is an email message, and wherein transmitting the message to the user affected by the service desk issue is performed via an email server.

23. The computer-readable medium of claim 21, wherein the message includes one or more of:
an identifier of the service desk issue;
a time the service desk issue was reported;
a summary of the service desk issue;
an identifier of a service desk agent responsible for handling the service desk issue; or
a time that a next notification related to the service desk issue is expected to be sent.

24. The computer-readable medium of claim 21, wherein the method further comprises:
prior to the transmitting the message to the user affected by the service desk issue, displaying the contents of the message on the display device; and
receiving an input from a user, wherein the input indicates that the message should be transmitted;
wherein transmitting the message to the user affected by the service desk issue is performed in response to the input from the user.
